(19) United States
(12) Patent Application Publication
(10) Pub. No.: US 2023/0247092 A1
(43) Pub. Date: Aug. 3, 2023

(54) ENABLING OFF-CHANNEL TRANSMISSIONS FOR WIRELESS NETWORKS

(71) Applicant: QUALCOMM Incorporated, San Diego, CA (US)

(72) Inventors: Abdel Karim AJAMI, San Diego, CA (US); Sai Yiu Duncan HO, San Diego, CA (US); George CHERIAN, San Diego, CA (US); Alfred ASTERJADHI, San Diego, CA (US); Abhishek Pramod PATIL, San Diego, CA (US); Gaurang NAIK, San Diego, CA (US); Yanjun SUN, San Diego, CA (US)

(21) Appl. No.: 17/591,585

(22) Filed: Feb. 2, 2022

(51) Int. Cl. H04L 67/1074

(52) U.S. Cl. CPC H04L 67/1078

(57) ABSTRACT

Certain aspects of the present disclosure relate to wireless communications and, more particularly. A method that may be performed by an access point (AP) includes obtaining, while communicating with at least one station on a first set of channels, information regarding a second set of channels not being currently used by the AP and outputting, for transmission, an off-channel indication that identifies one or more of the second set of channels that are available to the at least one station for peer-to-peer (P2P) communications with at least one other station.

### TECHNICAL FIELD

Certain aspects of the present disclosure generally relate to wireless communications and, more particularly, to enabling transmissions between devices on channels on which an access point is not operating.

### DESCRIPTION OF THE RELATED TECHNOLOGY

Wireless communications networks are widely deployed to provide various communications services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communications systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (such as tens of meters to a few hundred meters).

### SUMMARY

The systems, methods and devices of this disclosure each have several innovative aspects, no single one of which is solely responsible for the desirable attributes disclosed herein.

Certain aspects of the present disclosure provide a method for wireless communication at an access point (AP). The method generally includes obtaining, while communicating with at least one station on a first set of channels, information regarding a second set of channels not being currently used by the AP and outputting, for transmission, an off-channel indication that identifies one or more of the second set of channels that are available to the at least one station for peer-to-peer (P2P) communications with at least one other station.

Certain aspects of the present disclosure provide a method for wireless communication at a first station. The method generally includes obtaining, while communicating with at least one access point (AP) on a first set of channels, an off-channel indication that identifies a second set of one or more channels not being currently used by the AP and that are recommended to the first station for peer-to-peer (P2P) communications with at least one second station and participating in P2P communications with the at least one second station on one or more of the second set of channels.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure, and the description may admit to other equally effective aspects.

FIG. 1 is a diagram of an example wireless communications network, in accordance with certain aspects of the present disclosure.

FIG. 2 is a block diagram of an example access point (AP) and example wireless stations (STAs), in accordance with certain aspects of the present disclosure.

FIG. 3 illustrates an example wireless device, in accordance with certain aspects of the present disclosure.

FIG. 4 is a block diagram illustrating example multi-link operations between multi-link devices (MLDs), in accordance with certain aspects of the present disclosure.

FIG. 5 is an example scenario in which certain aspects of the present disclosure may be utilized.

FIG. 6 is an example transmission timeline illustrating the transmission of a group addressed frame at a pre-determined time, in accordance with certain aspects of the present disclosure.

FIG. 7 illustrates an example of how off-channel transmissions may be enabled, in accordance with certain aspects of the present disclosure.

FIG. 8 illustrates an example scenario with off-channel transmissions, in accordance with certain aspects of the present disclosure.

FIG. 9 illustrates an example scenario with off-channel transmissions, in accordance with certain aspects of the present disclosure.

FIG. 10 is an example timeline illustrating medium synchronization delay that may be mitigated using off-channel transmissions, in accordance with certain aspects of the present disclosure.

FIGS. 11-17 illustrate example signaling for enabling off-channel transmissions, in accordance with certain aspects of the present disclosure.

FIG. 18 is a flow diagram illustrating example operations for wireless communications at an AP, in accordance with certain aspects of the present disclosure.

FIG. 19 is a flow diagram illustrating example operations for wireless communications by a first station, in accordance with certain aspects of the present disclosure.

FIG. 20 illustrates a communications device that may include various components configured to perform operations for the techniques disclosed herein, in accordance with aspects of the present disclosure.

FIG. 21 illustrates a communications device that may include various components configured to perform operations for the techniques disclosed herein, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for enabling transmission on off-channels.

As used herein, the term off-channel generally refers to a channel in a wireless network that a network entity, such as an infrastructure access point (infra-AP) does not operate on. Off-channels may be used for non-infrastructure communications, such as peer-to-peer (P2P) communications between devices to improve performance and resource utilization. An infra-AP generally refers to an AP operating in an infrastructure mode. The infrastructure mode generally refers to a mode in which devices communicate with each other by first going through an AP (the infra-AP). The infra-AP mode may be contrasted with an ad-hoc mode (P2P, or non-infrastructure mode), in which devices or stations communicate directly with each other, without the use of an AP.

P2P devices include virtual reality (VR) devices, extended reality (XR), and augmented reality (AR) devices. Such devices have gained popularity and many have increased quality of service (QoS) requirements due to the nature of their use, for example, in enterprise and residential environments. Unfortunately, meeting these QoS requirements may be challenging, as link capacity where the AP operates does not typically scale well with P2P traffic, in addition to conventional (infrastructure) Uplink and Downlink traffic.

Aspects of the present disclosure, however, may help address this scalability issue by presenting mechanisms for efficiently identifying (non-infrastructure) off-channels suitable for P2P communications. The techniques may leverage the likelihood that the AP has a better view of network resources and can provide guidance regarding off-channel availability. The AP may also be able to help select service periods to orthogonalize the P2P transmissions on the off-channel.

The mechanisms proposed herein may help enable the coexistence of infrastructure and P2P communications in a scalable manner and may deployed in a variety of environments, such as enterprise and residential (mesh) deployments, while still providing the ability for IT managers to enforce policies, based P2P coexistence. As such, the mechanisms presented herein may help support for a relatively large number of P2P users, with improved performance and more efficient resource utilization.

### Overview of Wireless Communication Systems

Various aspects of the disclosure are described more fully hereinafter with reference to the accompanying drawings. This disclosure may, however, be implemented in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be implemented by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communications systems, including communications systems that are based on an orthogonal multiplexing scheme. Examples of such communications systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each subcarrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (such as implemented within or performed by) a variety of wired or wireless apparatuses (such as nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a tablet, a portable communications device, a portable computing device (such as a personal data assistant), an entertainment device (such as a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communications link.

### Example Wireless Communication System

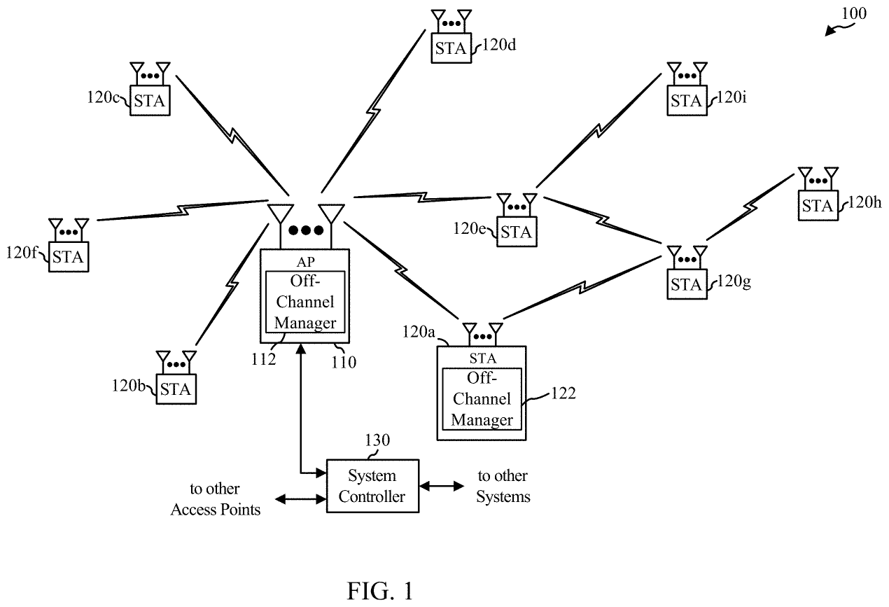

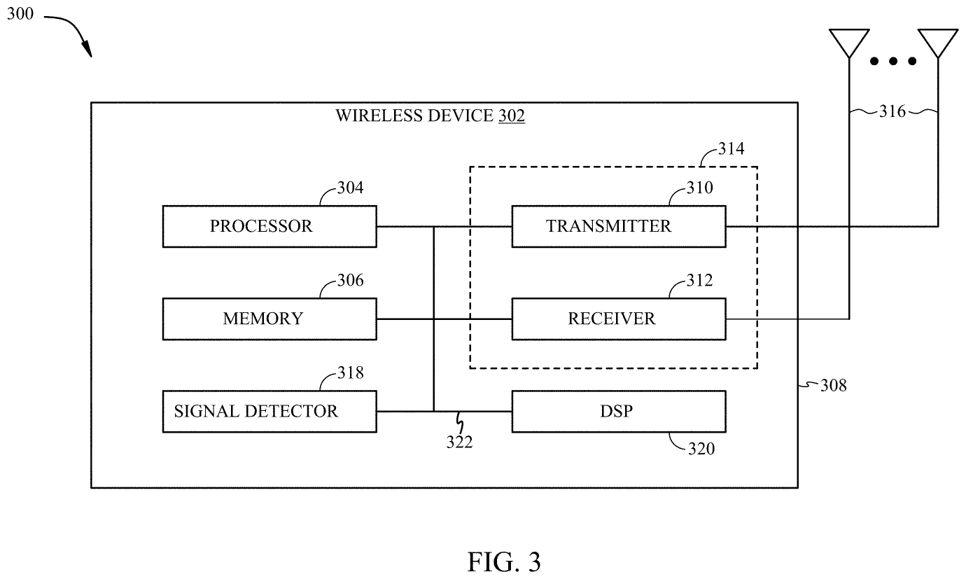

FIG. 1 is a diagram illustrating an example wireless communication system 100, in accordance with certain aspects of the present disclosure. System 100 may be a multiple-input multiple-output (MIMO)/multi-link operation (MLO) system 100. As shown in FIG. 1, an access point (AP) 110 includes an off-channel manager 112 that may be configured to take one or more actions described herein. The wireless station (STA) 120a includes an off-channel manager 122 that may be configured to take one or more actions described herein. In aspects, AP 110 and wireless station 120a may be MLDs as further described herein with respect to FIG. 3.

For simplicity, only one AP 110 is shown in FIG. 1. An AP is generally a fixed station that communicates with the wireless STAs and may also be referred to as a base station (BS) or some other terminology. A wireless STA may be fixed or mobile and may also be referred to as a mobile STA, a wireless device, or some other terminology. AP 110 may communicate with one or more wireless STAs 120 at any given moment on the downlink (DL) and/or uplink (UL). The DL (i.e., forward link) is the communication link from AP 110 to the wireless STAs 120, and the UL (i.e., reverse link) is the communication link from the wireless STAs 120 to AP 110. A wireless STA 120 may also communicate peer-to-peer with another wireless STA 120, for example, via a direct link such as a tunneled direct link setup (TDLS). A system controller 130 may be in communication with and provide coordination and control for the access points.

While portions of the following disclosure will describe wireless STAs 120 capable of communicating via Spatial Division Multiple Access (SDMA), for certain aspects, the wireless STAs 120 may also include some wireless STAs 120 that do not support SDMA. Thus, for such aspects, an AP 110 may be configured to communicate with both SDMA and non-SDMA wireless STAs 120. This approach may conveniently allow older versions of wireless STAs 120 (“legacy” stations) to remain deployed in an enterprise, extending their useful lifetime, while allowing newer SDMA wireless STAs 120 to be introduced as deemed appropriate.

System 100 employs multiple transmit and multiple receive antennas for data transmission on the DL and UL. AP 110 is equipped with Nₐₚ antennas and represents the multiple-input (MI) for DL transmissions and the multiple-output (MO) for UL transmissions. A set of K selected wireless stations 120 collectively represents the multiple-output for DL transmissions and the multiple-input for UL transmissions. For pure SDMA, it is desired to have Nₐₚ≥K≥1 if the data symbol streams for the K wireless STAs are not multiplexed in code, frequency or time by some means. K may be greater than Nₐₚ if the data symbol streams can be multiplexed using TDMA technique, different code channels with CDMA, disjoint sets of subbands with OFDM, and so on. Each selected wireless STA transmits user-specific data to and/or receives user-specific data from the access point. In general, each selected wireless STA may be equipped with one or multiple antennas (i.e., Nₛₜₐ≥1). The K selected wireless STAs can have the same or different number of antennas.

System 100 may be a time division duplex (TDD) system or a frequency division duplex (FDD) system. For a TDD system, the DL and UL share the same frequency band. For an FDD system, the DL and UL use different frequency bands. System 100 may also utilize a single carrier or multiple carriers for transmission. Each wireless STA may be equipped with a single antenna or multiple antennas. System 100 may also be a TDMA system if wireless STAs 120 share the same frequency channel by dividing transmission/reception into different time slots, each time slot being assigned to a different wireless STA 120.

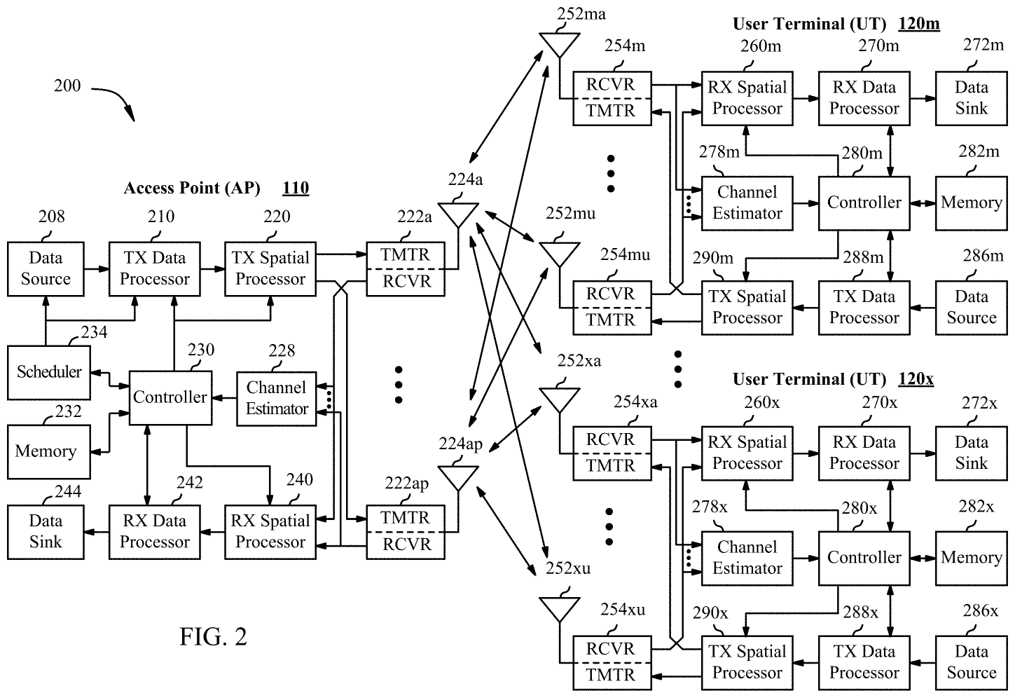

FIG. 2 illustrates a block diagram of AP 110 and two wireless STAs 120m and 120x in a MIMO/MLO system, such as system 100, in accordance with certain aspects of the present disclosure. In certain aspects, AP 110 and/or wireless STAs 120m and 120x may perform various techniques to ensure that a non-AP MLD is able to receive a group addressed frame. For example, AP 110 and/or wireless STAs 120m and 120x may include a respective off-channel manager as described herein with respect to FIG. 1.

AP 110 is equipped with Nₐₚ antennas 224a through 224t. Wireless STA 120m is equipped with N_{sta,m} antennas 252ma through 252mu, and wireless STA 120x is equipped with N_{sta,x} antennas 252xa through 252xu. AP 110 is a transmitting entity for the DL and a receiving entity for the UL. Each wireless STA 120 is a transmitting entity for the UL and a receiving entity for the DL. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “DL” denotes the downlink, the subscript “UL” denotes the uplink, N_{UL} wireless STAs are selected for simultaneous transmission on the uplink, N_{DL} wireless STAs are selected for simultaneous transmission on the downlink, N_{UL} may or may not be equal to N_{DL}, and N_{UL} and N_{DL} may be static values or can change for each scheduling interval. The beam-steering or some other spatial processing technique may be used at the access point and wireless station.

On the UL, at each wireless STA 120 selected for UL transmission, a transmit (TX) data processor 288 receives traffic data from a data source 286 and control data from a controller 280. TX data processor 288 processes (e.g., encodes, interleaves, and modulates) the traffic data for the wireless station based on the coding and modulation schemes associated with the rate selected for the wireless STA and provides a data symbol stream. A TX spatial processor 290 performs spatial processing on the data symbol stream and provides N_{sta,m} transmit symbol streams for the N_{sta,m} antennas. Each transceiver (TMTR) 254 receives and processes (e.g., converts to analog, amplifies, filters, and frequency upconverts) a respective transmit symbol stream to generate an uplink signal. N_{sta,m} transceivers 254 provide N_{sta,m} UL signals for transmission from N_{sta,m} antennas 252 to AP 110.

N_{UL} wireless STAs may be scheduled for simultaneous transmission on the uplink. Each of these wireless STAs performs spatial processing on its data symbol stream and transmits its set of transmit symbol streams on the UL to the AP 110.

At AP 110, Nₐₚ antennas 224a through 224ap receive the UL signals from all N_{UL}, wireless STAs transmitting on the UL. Each antenna 224 provides a received signal to a respective transceiver (RCVR) 222. Each transceiver 222 performs processing complementary to that performed by transceiver 254 and provides a received symbol stream. A receive (RX) spatial processor 240 performs receiver spatial processing on the Nₐₚ received symbol streams from Nₐₚ transceiver 222 and provides N_{UL} recovered UL data symbol streams. The receiver spatial processing is performed in accordance with the channel correlation matrix inversion (CCMI), minimum mean square error (MMSE), soft interference cancellation (SIC), or some other technique. Each recovered UL data symbol stream is an estimate of a data symbol stream transmitted by a respective wireless station. An RX data processor 242 processes (e.g., demodulates, deinterleaves, and decodes) each recovered uplink data symbol stream in accordance with the rate used for that stream to obtain decoded data. The decoded data for each wireless STA may be provided to a data sink 244 for storage and/or a controller 230 for further processing.

On the DL, at AP 110, a TX data processor 210 receives traffic data from a data source 208 for N_{DL} wireless stations scheduled for downlink transmission, control data from a controller 230, and possibly other data from a scheduler 234. The various types of data may be sent on different transport channels. TX data processor 210 processes (e.g., encodes, interleaves, and modulates) the traffic data for each wireless station based on the rate selected for that wireless station. TX data processor 210 provides N_{DL} DL data symbol streams for the N_{DL} wireless stations. A TX spatial processor 220 performs spatial processing (such as a precoding or beamforming, as described in the present disclosure) on the N_{DL} DL data symbol streams, and provides Nₐₚ transmit symbol streams for the Nₐₚ antennas. Each transceiver 222 receives and processes a respective transmit symbol stream to generate a DL signal. Nₐₚ transceivers 222 providing Nₐₚ DL signals for transmission from Nₐₚ antennas 224 to the wireless STAs.

At each wireless STA 120, N_{sta,m} antennas 252 receive the Nₐₚ DL signals from access point 110. Each transceiver 254 processes a received signal from an associated antenna 252 and provides a received symbol stream. An RX spatial processor 260 performs receiver spatial processing on N_{sta,m} received symbol streams from N_{sta,m} transceiver 254 and provides a recovered DL data symbol stream for the wireless station. The receiver spatial processing is performed in accordance with the CCMI, MMSE or some other technique. An RX data processor 270 processes (e.g., demodulates, deinterleaves and decodes) the recovered DL data symbol stream to obtain decoded data for the wireless station.

At each wireless STA 120, a channel estimator 278 estimates the DL channel response and provides DL channel estimates, which may include channel gain estimates, SNR estimates, noise variance and so on. Similarly, a channel estimator 228 estimates the UL channel response and provides UL channel estimates. Controller 280 for each wireless STA typically derives the spatial filter matrix for the wireless station based on the downlink channel response matrix H_{dn,m} for that wireless station. Controller 230 derives the spatial filter matrix for the AP based on the effective UL channel response matrix H_{up,eff}. Controller 280 for each wireless STA may send feedback information (e.g., the downlink and/or uplink eigenvectors, eigenvalues, SNR estimates, and so on) to the AP. Controllers 230 and 280 also control the operation of various processing units at AP 110 and wireless STA 120, respectively.

FIG. 3 illustrates various components that may be utilized in a wireless device 302 that may be employed within system 100, in accordance with certain aspects of the present disclosure. Wireless device 302 is an example of a device that may be configured to implement the various methods described herein. Wireless device 302 may be an AP 110 or a user terminal.

Wireless device 302 may include a processor 304 which controls operation of wireless device 302. Processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

Wireless device 302 may also include a housing 308 that may include a transmitter 310 and a receiver 312 to allow transmission and reception of data between the wireless device 302 and a remote location. Transmitter 310 and receiver 312 may be combined into a transceiver 314. A single or a plurality of transmit antennas 316 may be attached to the housing 308 and electrically coupled to the transceiver 314. Wireless device 302 may also include (not shown) multiple transmitters, multiple receivers, and multiple transceivers.

Wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. Wireless device 302 may also include a digital signal processor (DSP) 320 for use in processing signals.

The various components of wireless device 302 may be coupled together by a bus system 322, which may include a power bus, a control signal bus, and a status signal bus in addition to a data bus.

Certain aspects of the present disclosure are directed to apparatus and techniques for implementing multi-link communications. For example, certain aspects provide techniques for managing data flows for across multiple links by an MLD. Multiple bands may be implemented for wireless devices. For example, a wireless device may be able to support at least one of a 2.4 GHz band, a 5 GHz band or a 6 GHz band and operate over more than one link spread over these bands. With multi-link communications, data flows may be transmitted across multiple wireless links which may be associated with different bands.

In certain wireless communication networks (e.g., 802.11be networks), an MLD may be a wireless communication device with multiple affiliated APs 110 or STAs 120. The MLD may have a single MAC service access point (SAP) to a logical link control (LLC) layer. The MLD may also have a MAC address that uniquely identifies the MLD management entity. An MLD may support various MLOs. In aspects, MLO may include multi-band aggregation, where two or more channels at different bands (e.g., 2.4, 5, and 6 gigahertz (GHz) bands) are combined to achieve higher transmission rates. In aspects, the 6 GHz band may include a frequency range of 5.925-7.125 GHz. For example, a single frame may be split and transmitted simultaneously through the different channels at the different bands, reducing the frames transmission time or facilitating transmission of larger aggregated frames. MLO may include multi-band and multi-channel full duplex communications, which is achieved through transmitting and receiving on different channels (in the same or different bands) at the same time. MLO may include data and control plane separation on to different channels (in the same or different bands). In certain aspects, MLO may be implemented with a multi-link single radio (MLSR) architecture, where the multiple affiliated Aps 110 or STAs 120 of an MLD may be logical devices under a single radio. In certain aspects, MLO may be implemented with an enhanced multi-link single radio (EMLSR) architecture.

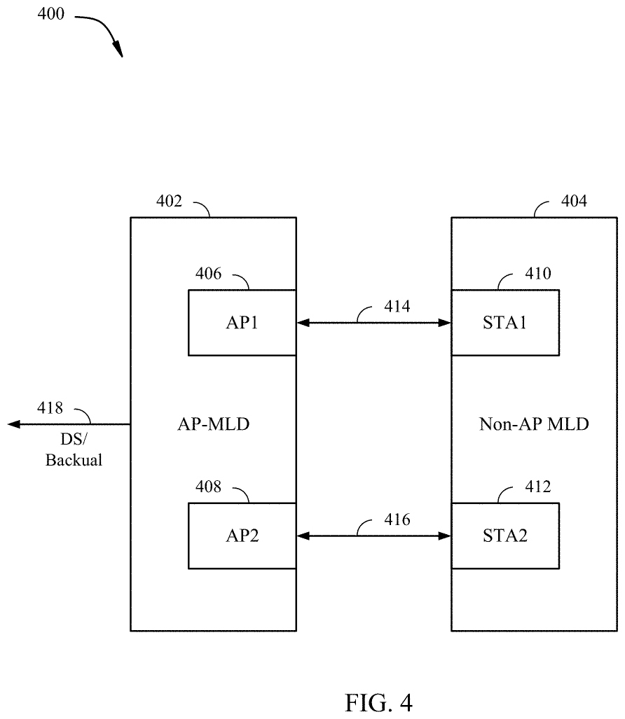

FIG. 4 is a block diagram 400 illustrating example MLOs between MLDs, in accordance with certain aspects of the present disclosure. As shown, an AP MLD 402 may communicate with a non-AP MLD 404 via multi-link communications, such as multi-band aggregation. The AP MLD 402 may also be in communication with other systems (e.g., a distribution system (DS) such as a local area network and/or a wide area network) via an interface 418, such as a backhaul interface. The AP MLD 402 may include at least two STA entities 406, 408 (sometimes referred to as STA instances and also referred to herein simply as STAs) that may communicate with associated STA entities 410, 412 of the non-AP MLD 404. An STA entity (or instance) of an AP MLD is generally an AP (which may be referred to as an AP-STA or an STA serving as an AP), and an STA entity of a non-AP MLD is generally a non-AP STA (which may be referred to simply as a STA). MLDs may use MLOs, such as multi-link aggregation (MLA) (which includes packet level aggregation), where MAC protocol data units (MPDUs) from a same traffic ID (TID) can be sent via two or more links 414, 416.

In aspects, each of the STA entities 406, 408 may communicate on separate bands (e.g., 2.4, 5, and 6 GHz bands), and similarly, each of the STA entities 410, 412 may communicate on separate bands (2.4, 5, and 6 GHz bands). For example, the STA entities 406, 410 may communicate with each other on a first link 414 via a first band (e.g., 5 GHz band), and the STA entities 408, 412 may communicate with each other on a second link 416 via a second band (e.g., 6 GHz band). The aggregated links 414, 416 may enable desirable throughputs and latencies between the AP MLD 402 and the non-AP MLD 404. In aspects, the STA entities (406, 408 or 410, 412) of an MLD may be implemented as separate devices or RF transceiver chips of the MLD, or the STA entities may be integrated into the same device or RF transceiver chip. In certain aspects, a link may refer to a physical path having one traversal of the wireless medium (WM) that is usable to transfer various packets, messages, or frames (such as MAC service data units (MSDUs)) between two STAs.

### Example Mechanisms for Enabling Off-Channel Transmissions

Aspects of the present disclosure provide apparatus, methods, processing systems, and computer readable mediums for enabling transmission on off-channels. The mechanisms may help enable the coexistence of infrastructure and P2P communications in a scalable manner by identifying off-channels suitable for P2P communications and conveying information regarding these off-channels to potential P2P devices.

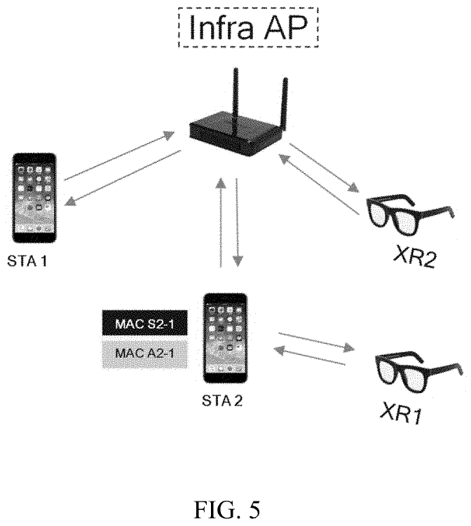

The techniques described herein may be utilized in a variety of environments where P2P devices, such as VR, AR, and/or XR devices, are deployed with devices operating in an infrastructure mode. The example wireless network 500 of FIG. 5 is one example of such a deployment. Such deployments may be found in locations where the infra-AP is not particularly flexible or accommodating of P2P links (such as apartments), as well as locations where the Infra-AP is more flexible or accommodating of P2P links (such as single family homes, retail, or enterprise deployments) with mesh network or single extended service set (ESS) scenarios.

In the example illustrated in FIG. 5, two (non-AP) stations (STA1 and STA2) a first XR device (XR2) communicate with an Infra AP, while STA2 communicates with a second XR device (XR1) via a P2P link. The P2P link may be established, for example, with STA2 acting as a soft AP and XR2 acting as a client, or via other P2P mechanisms, such as Neighbor Awareness Networking (NAN), or Tunneled Direct Link Setup (TDLS). In the illustrated example, XR2 is not associated with the Infra-AP.

In some cases, the Infra AP may use a single radio for infrastructure communications and to support P2P related communications (e.g., for gathering off-channel information). In other cases, the Infra AP may have an additional (auxiliary) radio that supports P2P related reception only or a separate (dedicated) radio that supports P2P related reception and transmission.

In some cases, one or both of STA1 and STA2 of the Infra-AP may be mobile phones and may be configured to act as a software enabled access point (soft AP). A soft AP (sometimes referred to as a virtual router) is a device with software enabling a device that is not specifically designed to be an access point, to provide some AP functionality. Such devices may or may not have an additional radio dedicated for P2P. If no additional radio is provided, a shared radio may need to be switched between P2P and infrastructure links. If the STA does have an additional radio, the additional radio may be an auxiliary radio that supports P2P related reception only or the additional radio may be a separate (dedicated) radio that supports P2P sessions.

As noted above, P2P clients for VR, AR, and/or XR applications typically have relatively stringent QoS requirements due to the nature of their use. Aspects of the present disclosure may help meet these QoS requirements while support scalability to a relatively large number of P2P users.

For example, according to certain aspects of the present disclosure, an Infra-AP may provide a recommendation or allocation of off-channels suitable for P2P operation. In such cases, the Infra-AP may obtain, while communicating with at least one station on a first set of channels, information regarding a second set of channels that the AP does not operate on (off-channels). The Infra-AP may then output, for transmission, an off-channel indication that identifies one or more of the second set of channels that are available to the at least one station for peer-to-peer (P2P) communications with at least one other station.

In some cases, the AP may recommends such P2P channels in a Beacon/Probe response mechanism. In some cases, the AP may obtain information (such as the loading) about off-channels (potential candidates for P2P communications) by off-channel scanning. The off-channel scanning may involve an auxiliary radio or obtaining assistance information from other clients.

The AP may process this information to identify the availability of off-channels to allocate or recommend to pairs of P2P clients to set up as P2P links. If the AP allocates off-channels to a pair of P2P clients, those clients may not have a choice but to use those off-channels. If the AP recommends off-channels, however, the P2P clients may be able to accept the recommended channels or request different off-channels. Whether to provide a recommendation or allocation may depend, for example, on the number of P2P clients deployed.

In some cases, each P2P pair may decide its own timing/periodicity of service periods (SPs) in which the devices communicate on an off-channel. Allowing the P2P devices to decide on their own SP timing may result in collisions with communications from other P2P pairs, if/when different P2P pairs decide on overlapping SPs.

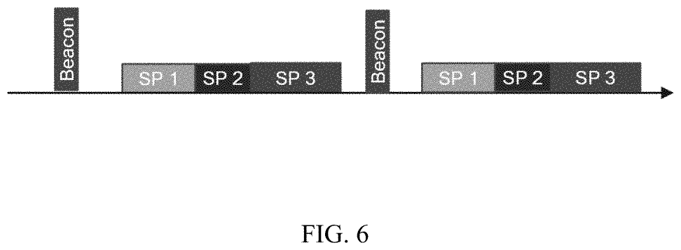

Therefore, in some cases, the AP may indicate both off-channel availability (recommendation or allocation) and service period (SP) availability. As with the off-channel availability, the SP availability may be indicated as a recommendation or allocation. As illustrated in FIG. 6, by allocating the off-channel SPs, the Infra AP may be able to orthogonalize the SPs for different P2P pairs, in order to minimize collisions when communicating on a common off-channel (or set of off-channels).

The example illustrated in FIG. 6 shows three orthogonal (non-overlapping) service periods: SP1, SP2, and SP3. Thus, STA/Soft APs interested in P2P transmissions may transition to an indicated off-channel (allocated/recommend for P2P communications) during one of the off-channel Service Periods. In some cases, the AP identifies and recommends service periods on a set of off-channels (AP does not operate on) to orthogonalize P2P transmissions.

As will be described in greater detail below, there are various options for signaling such SP allocations/recommendations. For example, the off channels and/or service periods may be identified using existing signaling. For example, available off-channels and corresponding SPs may be identified and conveyed by extending a Channel Usage Request and Response frame mechanism and/or a Channel Usage element.

An Infra AP may allocate Off-Channels, for example, if it is already supporting multiple P2P sessions and there are no more resources on the Infra AP operating links. In some cases, a STA associated with the Infra AP and acting also as Soft AP for XR device, may request channel resources from the Infra AP for use in a P2P session. The Infra AP may respond with an indication of available (allocated/recommended) off-channels and/or SPs.

In some cases, a STA may send the Infra AP a request to suspend or terminate an off-channel schedule determined by the service period availability indication. In such cases, the STA (and Infra AP) may suspend or terminate (or otherwise communicate independent of) the off-channel schedule in response to the request.

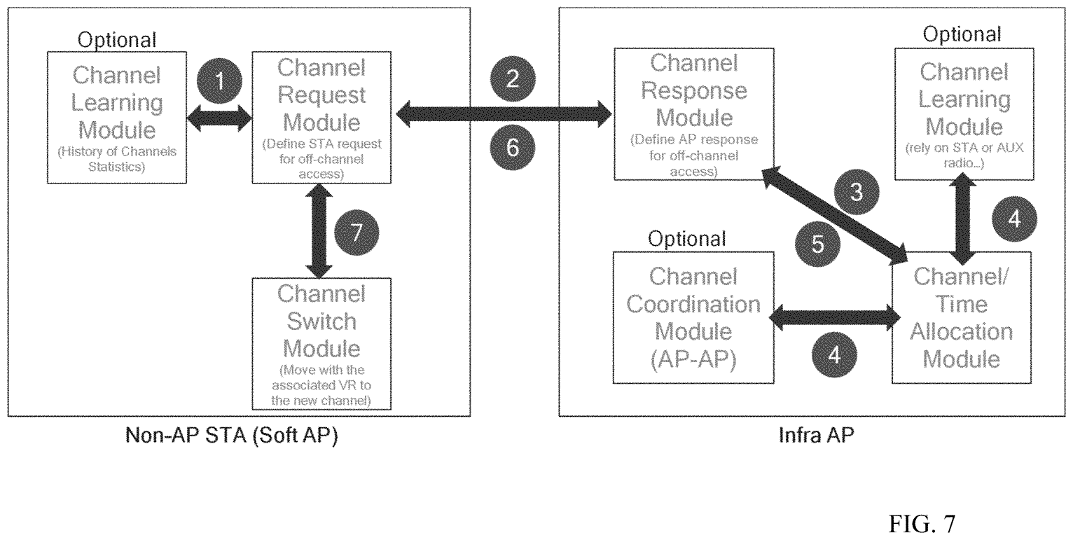

FIG. 7 illustrates an example sequence of operations for such a request and response exchange that may be performed by an Infra AP and (non-AP) STA, in accordance with aspects of the present disclosure. For example, the STA may be associated with the Infra AP and may also be acting also acting as Soft AP for an XR device. For example, STA2 of FIG. 5 may perform the operations shown in FIG. 7 to request channel resources from the Infra AP for a P2P session with XR1.

While the example shown in FIG. 7 illustrates certain modules in the Infra AP and STA capable of performing the various operation, the operations may be performed by any suitable such modules.

As illustrated, at an optional first step (Step 1), a Channel Request Module of the STA may query a Channel Learning Module (e.g., that has a history of channel statistics). In some cases, the STA may provide information obtained from the Channel Learning Module as feedback to the Infra-AP (to assist in determining suitable off-channels) and/or SPs.

At a second step (Step 2), the Channel Request Module may output, for transmission to (a Channel Response Module of) the Infra-AP, a STA request for off-channel access. Various signaling options are available for transition from a current link to a new off Channel, based on a P2P request/response with Off-Channel Support. According to one option, a modified Individual, broadcast, or restricted target wakeup time (TWT) request/response with a new field in a TWT information element (IE) or a new IE to indicate the Off Channel(s). According to a second option, a modified stream classification service (SCS) request/response may be used with a new field in a QoS Characteristics IE or a new IE to indicate the Off Channel(s). According to a third option, a new management frame may be defined with a new IE to indicate the Off Channel(s).

Referring back to FIG. 7, at a third step (Step 3), the channel response module may obtain off-channel and/or SP information by querying a Channel/Time Allocation module. As illustrated, the Channel/Time Allocation Module (at Step 4), may obtain off-channel and/or SP information from a Channel Learning Module or Channel Coordination Module. The Channel Learning Module may rely on information obtained from STAs or may obtain channel information via scanning, if equipped with an auxiliary radio.

The Channel Coordination Module may obtain channel and/or SP information from one or more STAs as STA-to-AP Channel Feedback, according to various options. According to one option, a new management frame may be defined with new fields (or a new IE) to indicate learned (off) channel information (e.g., learned via the Channel Learning Module). According to a second option, a beacon reporting mechanism may be used to send a Beacon Measurement request to certain STAs associated with it. In such cases, a Channel field may be set to 0 to indicate to a STA that it is to perform an iterative measurement of all the supported channels. The AP may indicate which (e.g., full/specific) IEs the STA is requested to report.

The Channel Coordination Module may obtain channel and/or SP information from one or more other APs. There are various options for signaling involved in such AP-to-AP Off-Channel Coordination. According to a first option, a new IE may be defined and included beacon and management frames. Such frames can be used by the AP to announce recommended (e.g., best) Off-Channel information (e.g., one or more channel numbers and associated load, allocated P2P sessions or SPs . . . ). According to a second option, a new management frame may be defined, with new fields (or a new IE) to indicate recommended Off-Channel information (e.g., one or more channel numbers and associated load, allocated P2P sessions or SPs . . . ). A new management frame may also be defined for broadcast services, based on a frame known as an enhanced broadcast services (EBCS) frame. In some cases, as part of this coordination, APs may agree on some channel(s) to be used for P2P only.

The Channel/Time Allocation Module may return (at Step 5) the off-channel and/or SP availability it obtains to the Channel Response Module. The Channel Response Module may incorporate this information into an AP response, defined for the off-channel Request from the STA (and sent to the STA at Step 6). The Channel Request Module may parse the Response and provide the off-channel and/or SP availability information to a Channel Switch Module, which may take action to move the associated P2P client (e.g., XR1) to a new off-channel indicated in the response.

The Infra-AP may select one or more off-channels to recommend/allocate for P2P links, using any suitable mechanisms. For example, an Infra-AP with no additional radio may perform periodic off-channel scanning (e.g., using channel measurements/loading reported from clients). On the other hand, an AP with an additional (auxiliary) radio that supports reception only may conduct off-channel scanning. In a fully managed network, an AP or APs may coordinate to provide centralized reservation of the P2P channels.

There are also various options for how an AP shares the off-channel and/or SP availability information for P2P links. According to a first option, an Infra-AP may share this information in broadcast frames (e.g., beacon, probe response, (re-) association, fast initial link setup (FILS) discovery, or EBCS frames), by defining a new Off-Channel IE. According to a second option, an Infra-AP may share this information via unicast frames (e.g., via a defined an Off-channel request/response). In some cases, an Infra-AP may share this information via a combination of these first and second options (e.g., using both broadcast and unicast signaling).

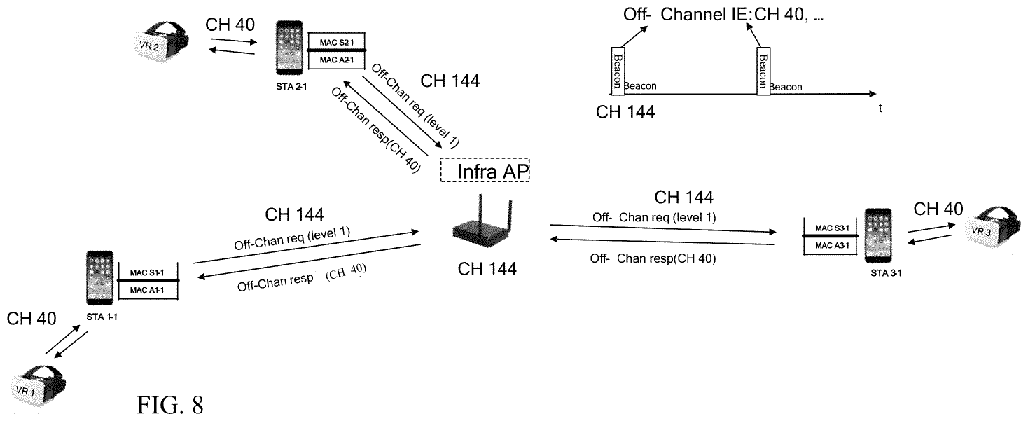

FIG. 8 illustrates an example scenario for P2P off-channel recommendation. A scenario in which off-channel availability information (but not SP information) is conveyed may be referred to herein as a Level 1 scenario. As illustrated, the example assumes that an off-channel CH 40 has been identified as an available off-channel. For example, the off-channel CH 40 may be identified via a beacon (e.g., transmitted on an infrastructure channel 144).

As illustrated, the off-channel CH 40 may be communicated, by the Infra AP to various (soft AP) STAs, STA 1-1, STA 2-1, and STA 3-1. Based on this information, these devices may establish a P2P link on CH 40 with their respective clients (VR 1, VR 2, and VR 3).

As noted above, based on off-channel availability information received, a STA/Soft AP may transition to an available (allocated/recommended) P2P channel during Off-channel Service Period. In some cases, P2P exchanges may be limited to Off-channel Service Periods. Each such Off-channel service period may be associated with an available Off-Channel and/or P2P pair.

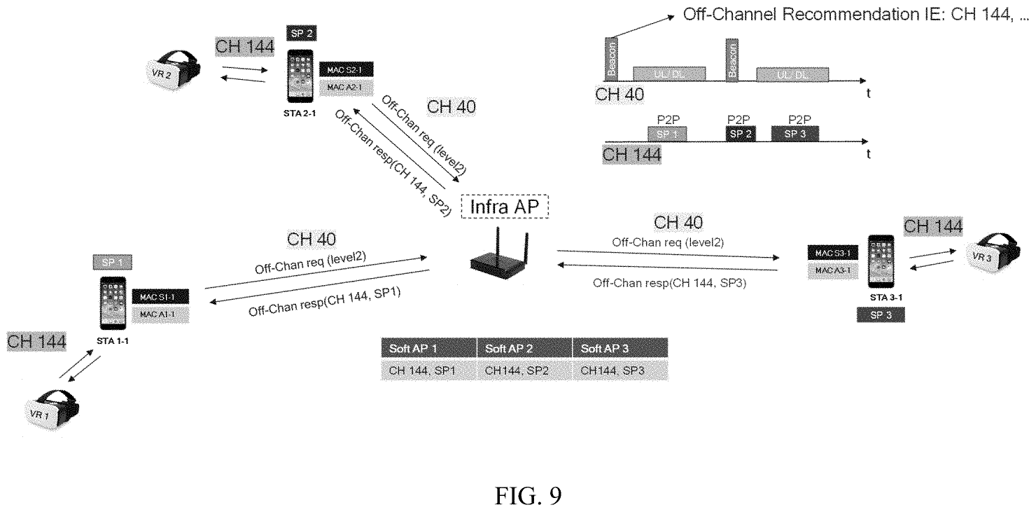

FIG. 9 illustrates an example scenario for both P2P off-channel and service recommendation. A scenario in which off-channel availability information and SP information are both conveyed may be referred to herein as a Level 2 scenario. As illustrated, the example assumes that an off-channel CH 144 has been identified as an available off-channel. For example, the off-channel CH 144 may be identified via a beacon (e.g., transmitted on an infrastructure channel 40).

In this case, three different orthogonal SPs may be identified for P2P communications using off-channel CH 144: SP1, SP2, and SP3. As illustrated, the off-channel CH 144 and corresponding SPs may be communicated, by the Infra AP to various (soft AP) STAs, STA 1-1, STA 2-1, and STA 3-1.

Based on this information, these devices may establish a P2P link on CH 144 with their respective clients (VR 1, VR 2, and VR 3), with P2P communications limited to the corresponding SPs. For example, in this example, P2P communications between STA 1-1 and VR 1 (on CH 144) may be limited to SP1, P2P communications between STA 2-1 and VR 2 (on CH 144) may be limited to SP2, while P2P communications between STA 3-1 and VR 3 (on CH 144) may be limited to SP3.

There are various options for how an Infra-AP may allocate such Off-channel service periods for P2P links. According to a first option, a unicast frame may be defined that is part of an Off-channel request/response mechanism. Such a frame may include both an Off-Channel IE and a new IE to indicate SP information, such as a start time, periodicity, and service period duration. In some cases, this SP information may also indicate a duration for which this allocation/recommendation remains valid.

According to a second option, a unicast frame may be defined that is part of a new Off-channel request/response that includes both Off-Channel IE and a TWT IE for SP information. According to a third option, a unicast frame may be defined by extending TWT request/response to include Off-channel IE in addition to a TWT IE. According to a fourth option, a unicast frame may be defined by extending an SCS request/response to include Off-channel IE in addition to a QoS Characteristics IE. According to a fifth option, broadcast frames may be defined that include both an Off-Channel IE and a TWT/new SP timing IE.

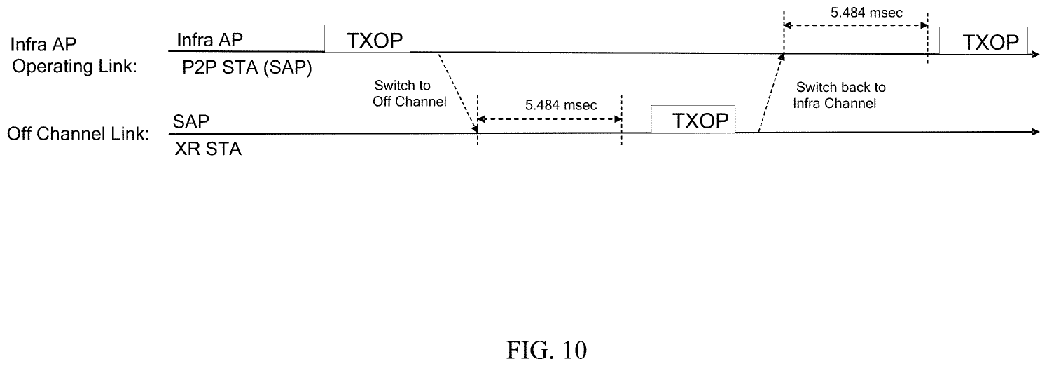

Certain aspects of the present disclosure may help reduce the delay associated with a device synchronizing to a medium after switching to a new off-channel. As illustrated in FIG. 10, a station may experience this type of medium synchronization delay when transitioning to a new channel, due to the conventional need to wait for a medium synchronization period, for example based on a network allocation vector (NAV). As illustrated in FIG. 10, this delay is typically around 5 ms (5.484 ms).

Aspects of the present disclosure may allow a station to avoid this delay. For example, if the STA receives a PPDU with a valid MPDU before the 5.484 ms delay, the STA may become in sync with the medium and can hence contend earlier for channel access.

There are various options for how aspects of the present disclosure may reduce this medium sync delay in this manner. According to one option, a P2P client (e.g., AR glasses) may be parked on a P2P channel. The P2P client may wake up at its TWT and send a request to send (RTS) or QoS Null message (e.g., with a PM=0) to the other peer STA (e.g., STA/soft AP). According to a second option, a STA/Soft AP with an auxiliary radio (e.g., with Rx only) may park (tune) the auxiliary radio on the off-channel which may keep the STA/Soft AP in sync with the medium at all times. In this case, the soft AP can initiate the transmission with the AR glass at any time, for example at the start of the TWT SP. According to a third option, an AP with an auxiliary radio that supports reception and transmission (Rx/Tx) in a fully scheduled mode, may send a message (e.g., an MU-RTS Trigger frame) to the Soft AP to schedule P2P traffic, which may bring the Soft AP in sync with the medium.

As noted above, aspects of the present disclosure may leverage the likelihood that the AP typically has a better view of network resources and can help to orthogonalize the P2P transmissions on the off-channel.

There are various options for how to signal off-channel and corresponding SP information. The signaling may include broadcast signaling, unicast signaling, or both. In some cases, a new IE may be defined to be carried in a broadcast frame (e.g., beacon, probe response, (re-) association, fast initial link setup (FILS) discovery, or EBCS frames) and/or a Unicast frame (e.g., Off-channel request/response).

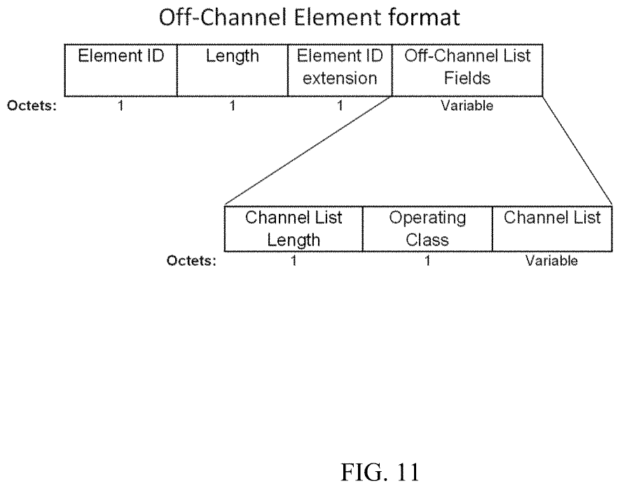

FIG. 11 illustrates an example format of such an IE. As illustrated, an off-channel element may include an off-channel list field with information for one or more off-channels. As illustrated, the off-channel list field may include a channel list length, operating class, and the channel list. The Operating Class and Channel List subfields together specify the channel frequency and channel bandwidth for channels that can be selected by the non-AP STA for Off-Channel transmissions.

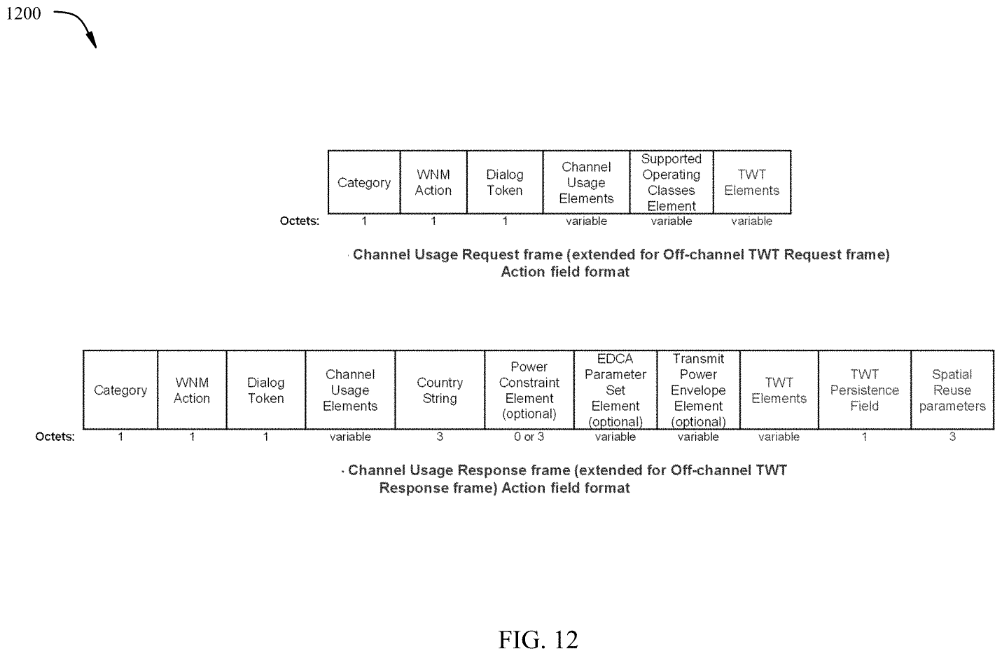

As illustrated in FIG. 12, in some cases, the off-channel and/or corresponding service period information may be conveyed using a form of channel usage request frame (an action frame) and response frames. As illustrated, such frames may include channel usage elements. A channel usage element may include a usage mode field that allows the indication of usage mode definitions and a channel entry field that defines an operating class and channel.

Referring back FIG. 12, the channel usage request frame may be extended to include TWT elements to serve as an Off-channel TWT request frame. In some cases, the TWT element may include individual, or broadcast or restricted TWT parameter sets. As illustrated, the response frame may include a TWT persistence field that indicates how long the indicated off-channel and/or corresponding SP information is valid.

As illustrated in FIG. 12, the response frame may also indicate spatial reuse parameters. For example, this field may indicate orthogonal BSS colors. Each soft AP may have an orthogonal BSS color and this field may indicate a flag that specifies that spatial reuse is to be used or required. Other elements in the response frame, such as power constraint and transmit power envelope elements may also be used and applied to the off-channels that are indicated.

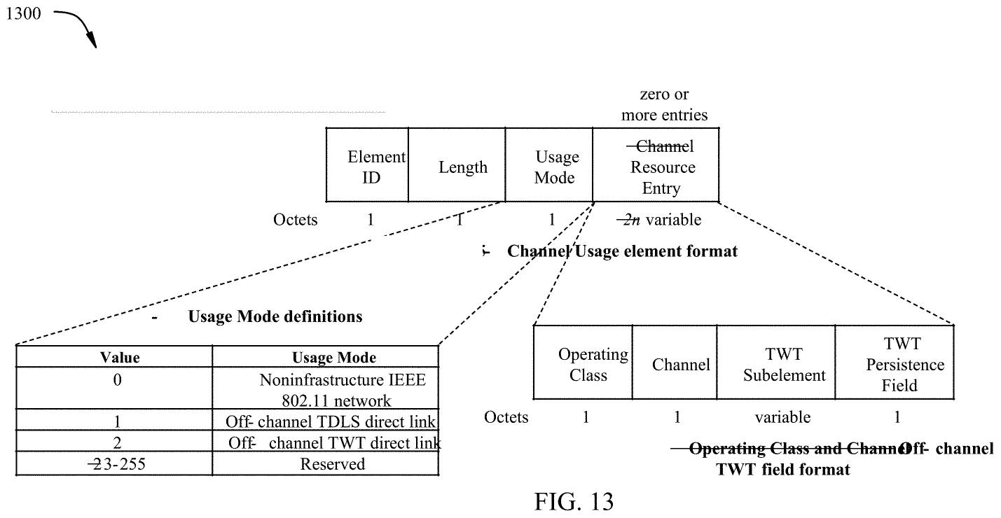

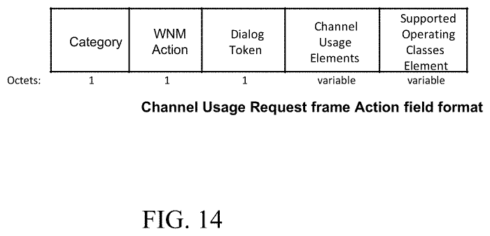

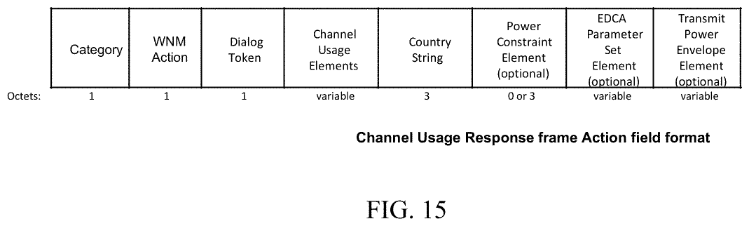

As illustrated in FIGS. 13, 14, and 15, according to a second option, the channel usage element may be revised to indicate (not just a channel, but) a group of fields that may define a usage mode. When this usage mode is set to indicate Off-channel TWT direct link, the Channel entry field may be interpreted differently, as a resource entry field. As illustrated, this field may include a TWT sub-element and TWT persistence field (indicating a “lease time” generally meaning how long this resource is available to the soft-AP). This could be in terms of absolute time (e.g., in ms) or in terms of Target Beacon Transmission Times (TBTTs).

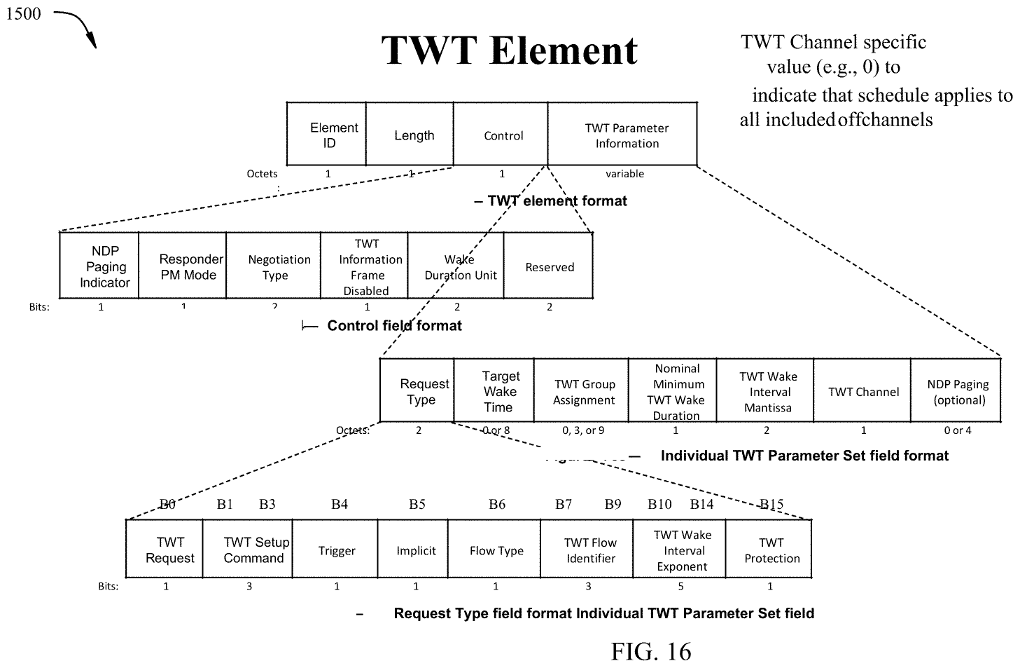

In some cases, each off-channel may have a corresponding schedule. In other cases, as illustrated in FIG. 16, in some cases, a TWT Channel subfield specific value may indicate that a corresponding schedule applies to all indicated off channels. For example, TWT channel subfield specific value set to zero may indicate that a schedule applies to all included/indicated off-channels. This may be a more efficient signaling mechanism, when compared to specifying separate TWT elements for each off-channel.

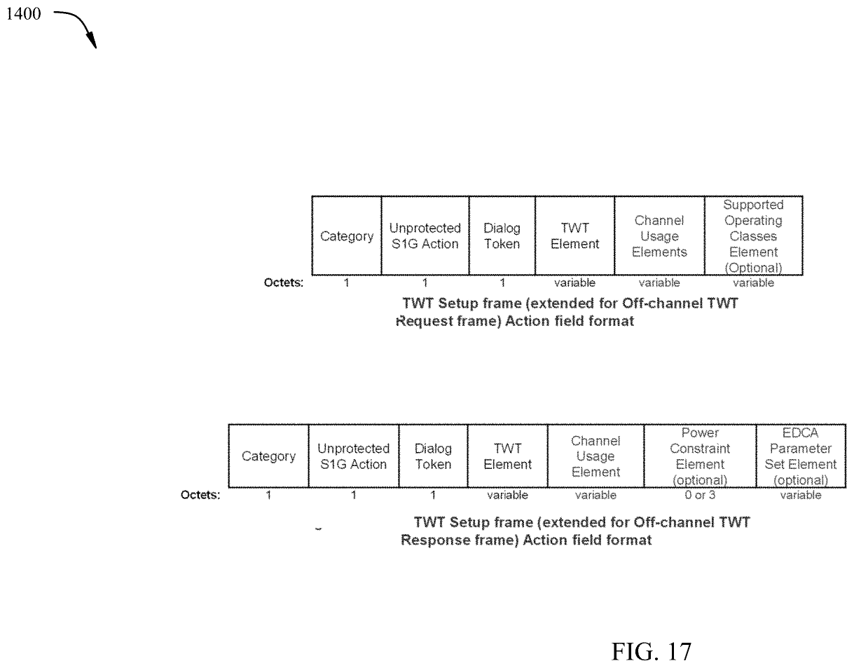

As illustrated in FIGS. 17, according to a third option, a TWT setup frame format may be extended to include channel usage elements and supported operating classes elements, that may help indicate an off-channel request and off-channel response frame.

A STA that indicates support of such an Off-channel TWT frame may send an Off-channel request frame. For example, such as STA may indicate via a dot11OffChannelTWTOptionImplemented equal to true support for Off-channel TWT and shall set to 1 the Off-channel TWT Support field of the Extended Capabilities elements that it transmits). A STA with the Off-channel TWT Support field set to true may send an Off-channel TWT request frame on behalf of its peer STA to request channel and service period information on the Off-channel. In some cases, the Channel Usage and TWT information may be provided by the AP to the non-AP STA to advise the STA on how to coexist with the infrastructure network.

In some cases, upon receiving an Off-channel TWT Request frame, the AP with Off-channel TWT Support field set to true shall send an Off-channel TWT Response frame including one or more TWT element(s) in addition to one Channel Usage element. In some cases, the AP Off-channel TWT Response frame may include one or more Operating Class and Channel field(s) in the Channel Usage element with Usage Mode field set to 0 or a new defined value (for example 2) where each field is associated with an individual TWT parameter set in the TWT element. In some cases, the index of the Operating Class and Channel field associated with an individual TWT parameter set may be indicated by the TWT Channel subfield.

In some cases, the Channel Usage element may include channels that are valid for the regulatory domain in which the AP transmitting the element is operating and consistent with the Country element in the Beacon or Probe Response frame; the Channel Usage elements shall not include any other channels. Upon receipt of a Channel Usage and TWT element in the Off-Channel TWT Response frame, the receiving STA with Off-channel TWT Support field set to true may use the following information. The receiving STA may use the channel usage and TWT information as part of channel and service period selection processing to start an Off-channel peer-to-peer link. The receiving station may also use the Power Constraint element, if present, as part of determining its maximum transmit power for transmissions for the off-channel peer-to-peer link. In some cases, the receiving STA may use an Enhanced distributed channel access (EDCA) Parameter Set element, if present, as part of determining its EDCA parameters for transmissions for the off-channel peer-to-peer link. The receiving station may also use the spatial reuse parameter set, if present.

### Example Operations

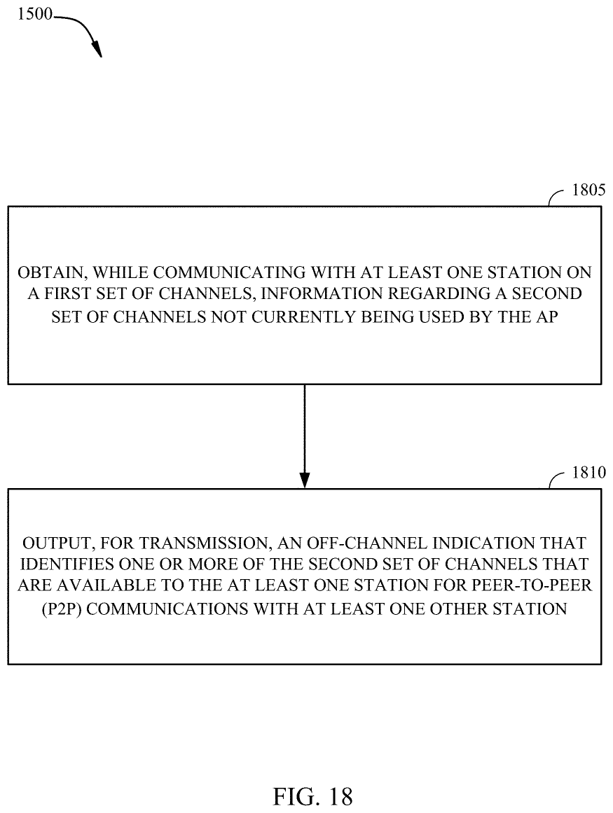

FIG. 18 is a flow diagram illustrating example operations 1800 for wireless communications, in accordance with certain aspects of the present disclosure. Operations 1800 may be performed, for example, by a wireless node, such as an AP.

Operations 1800 begin, at 1805, by obtaining, while communicating with at least one station on a first set of channels, information regarding a second set of channels not currently being used by the AP.

At 1810, the AP outputs, for transmission, an off-channel indication that identifies one or more of the second set of channels that are available to the at least one station for peer-to-peer (P2P) communications with at least one other station.

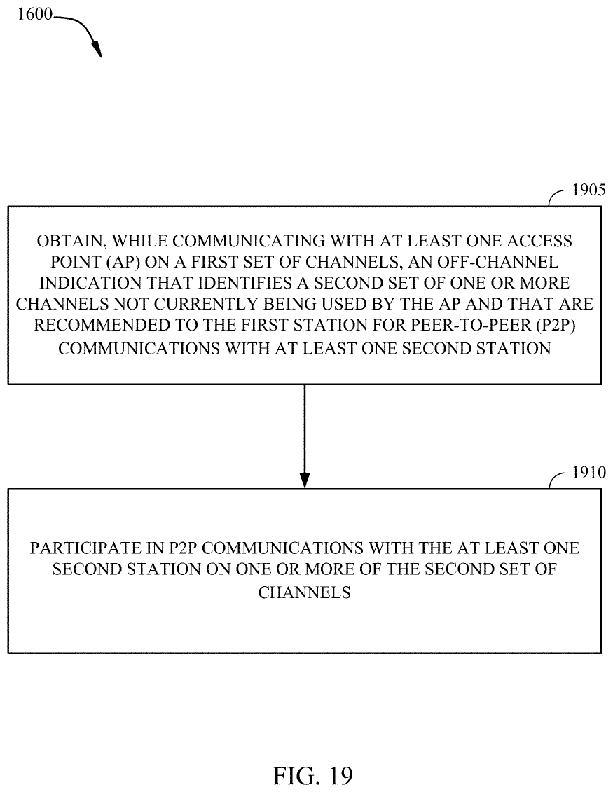

FIG. 19 is a flow diagram illustrating example operations 1900 for wireless communications by a first station, in accordance with certain aspects of the present disclosure. Operations 1900 may be performed, for example, by a wireless node, such as a non-AP STA. Operations 1900 may be complementary operations by the AP side operations 1800.

Operations 1900 begin, at 1905, by obtaining, while communicating with at least one access point (AP) on a first set of channels, an off-channel indication that identifies a second set of one or more channels that not being currently used by the AP that are recommended to the first station for peer-to-peer (P2P) communications with at least one second station.

At 1910, the first station participating in P2P communications with the at least one second station on one or more of the second set of channels.

The various operations of methods described above may be performed by any suitable means capable of performing the corresponding functions. The means may include various hardware or software component(s) or module(s), including, but not limited to a circuit, an application specific integrated circuit (ASIC), or processor. Generally, where there are operations illustrated in figures, those operations may have corresponding counterpart means-plus-function components with similar numbering.

### Example Devices

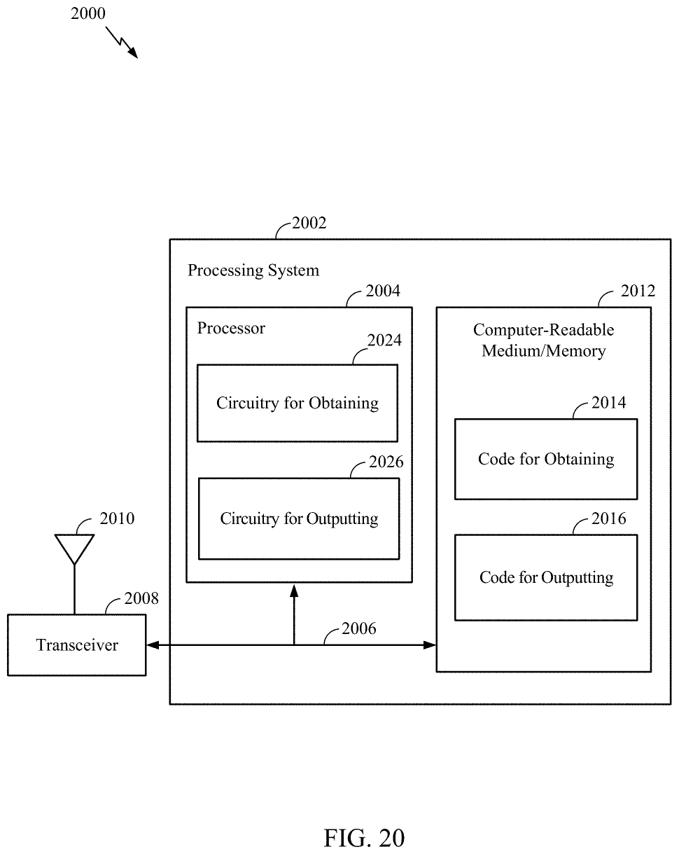

FIG. 20 illustrates a communications device 2000 that may include various components (such as corresponding to means-plus-function components) operable, configured, or adapted to perform operations for the techniques disclosed herein, such as the operations illustrated in FIG. 18.

Communications device 2000 includes a processing system 2002 coupled to a transceiver 2008 (such as a transmitter or a receiver). Transceiver 2008 is configured to transmit and receive signals for the communications device 2000 via an antenna 2010, such as the various signals as described herein. Processing system 2002 may be configured to perform processing functions for the communications device 2000, including processing signals received or to be transmitted by the communications device 2000.

Processing system 2002 includes a processor 2004 coupled to a computer-readable medium/memory 2012 via a bus 2006. In certain aspects, computer-readable medium/memory 2012 is configured to store instructions (such as computer-executable code) that when executed by processor 2004, cause processor 2004 to perform the operations illustrated in FIG. 18, or other operations for performing the various techniques discussed herein for MLOs.

In certain aspects, computer-readable medium/memory 2012 stores code 2014 (such as an example of means for) for obtaining and code 2016 (such as an example of means for) for outputting.

In certain aspects, processor 2004 has circuitry configured to implement the code stored in the computer-readable medium/memory 2012. Processor 2004 includes circuitry 2024 (such as an example of means for) for obtaining and circuitry 2026 (such as an example of means for) for outputting.

Transceiver 2008 may provide a means for receiving information such as packets, user data, or control information associated with various information channels (such as control channels, data channels, etc.). Information may be passed on to other components of the device 2000. Transceiver 2008 may be an example of aspects of the transceiver 254 described with reference to FIG. 2. Antenna 2010 may correspond to a single antenna or a set of antennas. Transceiver 2008 may provide means for transmitting signals generated by other components of the device 2000.

For example, means for transmitting (or means for outputting for transmission) may include a transmitter (such as the transmitter unit 222) or an antenna(s) 224 of AP 110 or the transmitter unit 254 or antenna(s) 252 of the STA 120 illustrated in FIG. 2. Means for receiving (or means for obtaining) may include a receiver (such as the receiver unit 222) or an antenna(s) 224 of AP 110 or the receiver unit 254 or antenna(s) 252 of STA 120 illustrated in FIG. 2. Means for communicating may include a transmitter, a receiver or both. Means for obtaining, means for participating, and means for selecting, means for suspending, and/or means for terminating may include a processing system, which may include one or more processors, such as the RX data processor 242, the TX data processor 210, the TX spatial processor 220, or the controller 230 of AP 110 or the RX data processor 270, the TX data processor 288, the TX spatial processor 290, or the controller 280 of STA 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

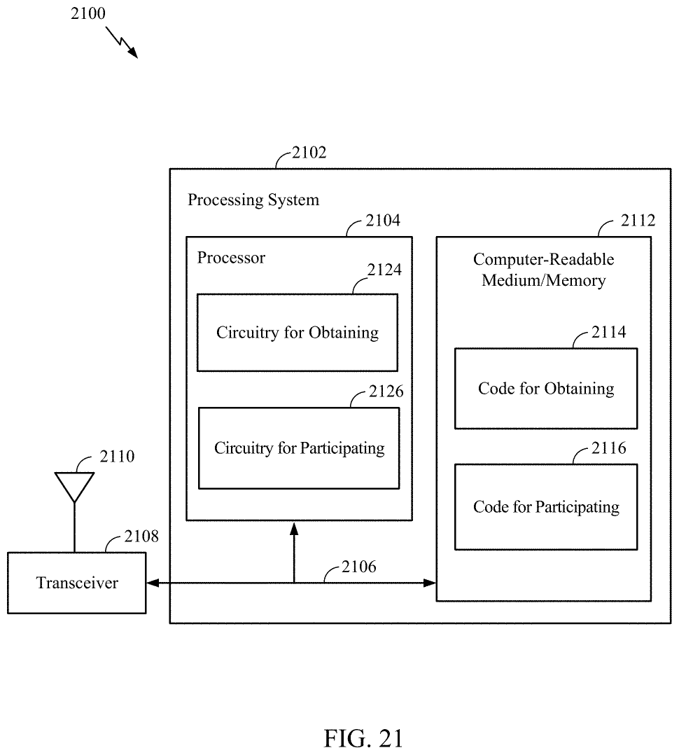

FIG. 21 illustrates a communications device 2100 that may include various components (such as corresponding to means-plus-function components) operable, configured, or adapted to perform operations for the techniques disclosed herein, such as the operations illustrated in FIG. 19.

Communications device 2100 includes a processing system 2102 coupled to a transceiver 2108 (such as a transmitter or a receiver). Transceiver 2108 is configured to transmit and receive signals for the communications device 2100 via an antenna 2110, such as the various signals as described herein. Processing system 2102 may be configured to perform processing functions for the communications device 2100, including processing signals received or to be transmitted by the communications device 2100.

Processing system 2102 includes a processor 2104 coupled to a computer-readable medium/memory 2112 via a bus 2106. In certain aspects, computer-readable medium/memory 2112 is configured to store instructions (such as computer-executable code) that when executed by processor 2104, cause processor 2104 to perform the operations illustrated in FIG. 19, or other operations for performing the various techniques discussed herein for MLOs.

In certain aspects, computer-readable medium/memory 2112 stores code 2114 (such as an example of means for) for obtaining and code 2116 (such as an example of means for) for participating.

In certain aspects, processor 2104 has circuitry configured to implement the code stored in the computer-readable medium/memory 2112. Processor 2104 includes circuitry 2124 (such as an example of means for) for obtaining and circuitry 2126 (such as an example of means for) for participating.

Transceiver 2108 may provide a means for receiving information such as packets, user data, or control information associated with various information channels (such as control channels, data channels, etc.). Information may be passed on to other components of the device 2100. Transceiver 2108 may be an example of aspects of the transceiver 254 described with reference to FIG. 2. Antenna 2110 may correspond to a single antenna or a set of antennas. Transceiver 2108 may provide means for transmitting signals generated by other components of the device 2100.

For example, means for transmitting (or means for outputting for transmission) may include a transmitter (such as the transmitter unit 222) or an antenna(s) 224 of AP 110 or the transmitter unit 254 or antenna(s) 252 of the STA 120 illustrated in FIG. 2. Means for receiving (or means for obtaining) may include a receiver (such as the receiver unit 222) or an antenna(s) 224 of AP 110 or the receiver unit 254 or antenna(s) 252 of STA 120 illustrated in FIG. 2. Means for communicating may include a transmitter, a receiver or both. Means for establishing and means for taking one or more actions may include a processing system, which may include one or more processors, such as the RX data processor 242, the TX data processor 210, the TX spatial processor 220, or the controller 230 of AP 110 or the RX data processor 270, the TX data processor 288, the TX spatial processor 290, or the controller 280 of STA 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface. As used herein, the term communicating may include obtaining, outputting, receiving or transmitting.

### Example Aspects

Implementation examples are described in the following numbered aspects:

Aspect 1: A method for wireless communications at an access point (AP), comprising: obtaining, while communicating with at least one station on a first set of channels, information regarding a second set of channels not currently being used by the AP; and outputting, for transmission, an off-channel indication that identifies one or more of the second set of channels that are available to the at least one station for peer-to-peer (P2P) communications with at least one other station.

Aspect 2: The method of Aspect 1, wherein the off-channel indication identifies one of one or more of the second set of channels that are at least one of allocated or recommended by the AP to the at least one station for P2P communications with at least one other station.

Aspect 3: The method of any one of Aspects 1-2, wherein: the information regarding the second set of channels comprises channel loading information for the second set of channels; and the method further comprises selecting the one or more of the second channels to be recommended in the off-channel indication based on the channel loading information.

Aspect 4: The method of Aspect 3, wherein the channel loading information is obtained via an auxiliary radio separate from a radio used for communicating with the at least one station on the first set of channels.

Aspect 5: The method of Aspect 3, wherein the channel loading information is obtained from at least one of: one or more stations; or one or more other APs.

Aspect 6: The method of any one of Aspects 1-5, wherein the off-channel indication is outputted for transmission in an information element (IE) via at least one of a broadcast frame or a unicast frame.

Aspect 7: The method of Aspect 6, wherein the IE includes one or more fields that collectively specify at least one of a channel frequency or bandwidth for each of the second set of channels.

Aspect 8: The method of Aspect 6, wherein at least one of: the broadcast frame comprises a beacon frame or a probe response frame; or the unicast frame comprises a response frame sent in response to a request for the off-channel indication.

Aspect 9: The method of any one of Aspects 1-8, further comprising outputting, for transmission, a service period availability indication for determining when the at least one station is permitted to use the one or more of the second set of channels that are recommended to the at least one station for P2P communications.

Aspect 10: The method of Aspect 9, further comprising: obtaining, from the at least one station, a request to suspend or terminate an off-channel schedule determined by the service period availability indication; and communicating independent of the off-channel schedule in response to the request.

Aspect 11: The method of Aspect 9, further comprising: obtaining, from the at least one station, an indication that the at least one station is capable of participating in P2P communications during an off-channel schedule determined by the service period availability indication; and outputting the off-channel indication and service period availability indication after obtaining the indication.

Aspect 12: The method of Aspect 9, wherein the service period availability indication comprises at least one of: a start time, periodicity, a service period duration, a persistence field that indicates duration for which the service period availability remains valid, or a field that specifies one or more spatial reuse parameters.

Aspect 13: The method of Aspect 9, wherein outputting, for transmission, the service period availability indication comprises outputting the service period availability indication via at least one of: a target wakeup time (TWT) element, a parameter set, or an information element.

Aspect 14: The method of Aspect 9, further comprising: obtaining, from the at least one station, a request frame, wherein the service period availability indication is outputted for transmission in an information element (IE) via a response to the request frame.

Aspect 15: The method of Aspect 14, wherein the request frame indicates one or more operating classes that the at least one station supports.

Aspect 16: The method of Aspect 14, wherein the response indicates additional information related to operation on the one or more second set of channels.

Aspect 17: The method of Aspect 9, further comprising selecting non-overlapping service period allocations for different stations.

Aspect 18: A method for wireless communications at a first station, comprising: obtaining, while communicating with at least one access point (AP) on a first set of channels, an off-channel indication that identifies a second set of one or more channels not currently being used by the AP that are recommended to the first station for peer-to-peer (P2P) communications with at least one second station; and participating in P2P communications with the at least one second station on one or more of the second set of channels.

Aspect 19: The method of Aspect 18, wherein the off-channel indication identifies one of one or more of the second set of channels that are at least one of allocated or recommended by the AP to the at least one station for P2P communications with at least one other station.

Aspect 20: The method of any one of Aspects 18-19, further comprising outputting, for transmission to the AP, channel loading information for selecting the second set of one or more channels.

Aspect 21: The method of any one of Aspects 18-20, wherein obtaining the off-channel indication comprises obtaining the off-channel indication from the AP in an information element (IE) via at least one of a broadcast frame or a unicast frame.

Aspect 22: The method of Aspect 21, wherein the IE includes one or more fields that collectively specify at least one of a channel frequency or bandwidth for each of the second set of channels.

Aspect 23: The method of Aspect 21, wherein at least one of: the broadcast frame comprises at least one of a beacon frame or a probe response frame; or the unicast frame comprises a response frame sent in response to a request for the off-channel indication.

Aspect 24: The method of any one of Aspects 18-23, further comprising: obtaining, from the AP, a service period availability indication for determining when the at least one station is permitted to use the one or more of the second set of channels that are recommended to the at least one station for P2P communications, wherein: the first station participates in P2P communications with the at least one second station on one or more of the second set of channels in accordance with the service period availability.

Aspect 25: The method of Aspect 24, wherein the service period availability indication comprises at least one of: a start time, periodicity, a service period duration, a persistence field that indicates duration for which the service period availability remains valid, or a field that specifies one or more spatial reuse parameters.

Aspect 26: The method of Aspect 24, wherein obtaining the service period availability indication comprises obtaining the service period availability indication, from the AP, in an information element (IE) via a unicast frame.

Aspect 27: The method of Aspect 26, further comprising: outputting, for transmission to the AP, a request frame, wherein the unicast frame comprises a response to the request frame that also includes the off-channel indication.

Aspect 28: The method of any one of Aspects 18-28, further comprising: obtaining medium synchronization on the one or more of the second set of channels; and participating in P2P communications with the at least one second station on one or more of the second set of channels without waiting for expiration of a medium synchronization timer after obtaining the medium synchronization.

Aspect 29: The method of Aspect 28, wherein obtaining medium synchronization comprises: obtaining a frame from the at least one second station on the one or more of the second set of channels; or obtaining a frame from the at least one AP.

Aspect 30: The method of Aspect 28, wherein obtaining medium synchronization involves an auxiliary radio separate from a radio used for communicating with the at least one AP on the first set of channels.

Aspect 31: An apparatus for wireless communications, comprising: a memory comprising instructions; and one or more processors configured to execute the instructions and cause the apparatus to perform a method in accordance with any one of Aspects 1-17.

Aspect 32: An apparatus for wireless communications, comprising: a memory comprising instructions; and one or more processors configured to execute the instructions and cause the apparatus to perform a method in accordance with any one of Aspects 18-30.

Aspect 33: An access point (AP), comprising: at least one transceiver; a memory comprising instructions; and one or more processors configured to execute the instructions and cause the access point to perform a method in accordance with any one of Aspects 1-17, wherein the at least one transceiver is configured to receive the information or transmit the off-channel indication.

Aspect 34: A first station, comprising: at least one transceiver; a memory comprising instructions; and one or more processors configured to execute the instructions and cause the network entity to perform a method in accordance with any one of Aspects 18-30, wherein the at least one transceiver is configured to receive the off-channel indication.

Aspect 35: An apparatus for wireless communications, comprising means for performing a method in accordance with any one of Aspects 1-17.

Aspect 36: An apparatus for wireless communications, comprising means for performing a method in accordance with any one of Aspects 18-30.

Aspect 37: A non-transitory computer-readable medium comprising instructions that, when executed by an apparatus, cause the apparatus to perform a method in accordance with any one of Aspects 1-17.

Aspect 38: A non-transitory computer-readable medium comprising instructions that, when executed by an apparatus, cause the apparatus to perform a method in accordance with any one of Aspects 18-30.

### ADDITIONAL CONSIDERATIONS

As used herein, the term “determining” encompasses a wide variety of actions. For example, “determining” may include calculating, computing, processing, deriving, investigating, looking up (such as looking up in a table, a database or another data structure), ascertaining and the like. Also, “determining” may include receiving (such as receiving information), accessing (such as accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus for wireless communications, comprising:
a memory comprising instructions; and
one or more processors configured to execute the instructions and cause the apparatus to:
obtain, while communicating with at least one station on a first set of channels, information regarding a second set of channels not currently being used by the apparatus;
output, for transmission, an off-channel indication that identifies one or more of the second set of channels that are recommended to the at least one station for peer-to-peer (P2P) communications with at least one other station; and
output, for transmission, a service period availability indication that indicates when the at least one station is permitted to use the one or more of the second set of channels that are recommended to the at least one station for P2P communications.

2. (canceled)

3. The apparatus of claim 1, wherein:
the information regarding the second set of channels comprises channel loading information for the second set of channels; and
the one or more processors are configured to execute the instructions and cause the apparatus to select the one or more of the second set of channels to be recommended in the off-channel indication based on the channel loading information.

4. The apparatus of claim 3, wherein the channel loading information is obtained via an auxiliary radio separate from a radio used for communicating with the at least one station on the first set of channels.

5. The apparatus of claim 3, wherein the channel loading information is obtained from at least one of:
one or more stations; or
one or more other apparatuses.

6. The apparatus of claim 1, wherein the off-channel indication is outputted for transmission in an information element (IE) via at least one of a broadcast frame or a unicast frame.

7. The apparatus of claim 6, wherein the IE includes one or more fields that collectively specify at least one of a channel frequency or bandwidth for each of the second set of channels.

8. The apparatus of claim 6, wherein at least one of:
the broadcast frame comprises a beacon frame or a probe response frame; or
the unicast frame comprises a response frame sent in response to a request for the off-channel indication.

9. (canceled)

10. The apparatus of claim 1, wherein the one or more processors are further configured to execute the instructions and cause the apparatus to:
obtain, from the at least one station, a request to suspend or terminate an off-channel schedule determined by the service period availability indication; and
communicate independent of the off-channel schedule in response to the request.

11. The apparatus of claim 1, wherein the one or more processors are further configured to execute the instructions and cause the apparatus to:
obtain, from the at least one station, an indication that the at least one station is capable of participating in P2P communications during an off-channel schedule determined by the service period availability indication; and
output the off-channel indication and service period availability indication after obtaining the indication.

12. The apparatus of claim 1, wherein the service period availability indication comprises at least one of: a start time, periodicity, a service period duration, a persistence field that indicates duration for which the service period availability remains valid, or a field that specifies one or more spatial reuse parameters.

13. The apparatus of claim 1, wherein outputting, for transmission, the service period availability indication comprises outputting the service period availability indication via at least one of: a target wakeup time (TWT) element, a parameter set, or an information element.

14. The apparatus of claim 1, wherein the one or more processors are further configured to execute the instructions and cause the apparatus to:
obtain, from the at least one station, a request frame, wherein the service period availability indication is outputted for transmission in an information element (IE) via a response to the request frame.

15. The apparatus of claim 14, wherein the request frame indicates one or more operating classes that the at least one station supports.

16. The apparatus of claim 14, wherein the response indicates additional information related to operation on the one or more second set of channels.

17. The apparatus of claim 1, wherein the one or more processors are further configured to execute the instructions and cause the apparatus to select non-overlapping service period allocations for different stations.

18. An apparatus for wireless communications, comprising:
a memory comprising instructions; and
one or more processors configured to execute the instructions and cause the apparatus to:
obtain, while communicating with at least one access point (AP) on a first set of channels, an off-channel indication that identifies a second set of one or more channels not currently being used by the AP that are recommended to the apparatus for peer-to-peer (P2P) communications with at least one other apparatus;
obtain, from the AP, a service period availability indication that indicates when the apparatus is permitted to use the one or more of the second set of one or more channels that are recommended to the apparatus for P2P communications; and
participate in P2P communications with the at least one other apparatus on one or more of the second set of one or more channels in accordance with the service period availability.

19. (canceled)

20. The apparatus of claim 18, wherein the one or more processors are further configured to execute the instructions and cause the apparatus to output, for transmission to the AP, channel loading information for selecting the second set of one or more channels.

21. The apparatus of claim 18, wherein obtaining the off-channel indication comprises obtaining the off-channel indication from the AP in an information element (IE) via at least one of a broadcast frame or a unicast frame.

22. The apparatus of claim 21, wherein the IE includes one or more fields that collectively specify at least one of a channel frequency or bandwidth for each of the second set of one or more channels.

23. The apparatus of claim 21, wherein at least one of:
the broadcast frame comprises at least one of a beacon frame or a probe response frame; or
the unicast frame comprises a response frame sent in response to a request for the off-channel indication.

24. (canceled)

25. The apparatus of claim 18, wherein the service period availability indication comprises at least one of: a start time, periodicity, a service period duration, a persistence field that indicates duration for which the service period availability remains valid, or a field that specifies one or more spatial reuse parameters.

26. The apparatus of claim 18, wherein obtaining the service period availability indication comprises obtaining the service period availability indication, from the AP, in an information element (IE) via a unicast frame.

27. The apparatus of claim 26, wherein the one or more processors are further configured to execute the instructions and cause the apparatus to:
output, for transmission to the AP, a request frame, wherein the unicast frame comprises a response to the request frame that also includes the off-channel indication.

28. The apparatus of claim 18, wherein the one or more processors are further configured to execute the instructions and cause the apparatus to:
obtain medium synchronization on the one or more of the second set of channels; and
participate in P2P communications with the at least one other apparatus on one or more of the second set of channels without waiting for expiration of a medium synchronization timer after obtaining the medium synchronization.

29. The apparatus of claim 15, further comprising at least one transceiver configured to receive the off-channel indication, wherein the apparatus is configured as a wireless station.

30. An access point (AP), comprising:
at least one transceiver;
a memory comprising instructions; and
one or more processors configured to execute the instructions and cause the AP to:
receive, via the at least one transceiver while communicating with at least one station on a first set of channels, information regarding a second set of channels not currently being used by the AP;
transmit, via the at least one transceiver, an off-channel indication that identifies one or more of the second set of channels that are recommended to the at least one station for peer-to-peer (P2P) communications with at least one other station; and
output, for transmission, a service period availability indication that indicates when the at least one station is permitted to use the one or more of the second set of channels that are recommended to the at least one station for P2P communications.
